(19) United States
(12) Patent Application Publication
(10) Pub. No.: US 2004/0009389 A1
(43) Pub. Date: Jan. 15, 2004

(54) Electrode material, membrane-electrode assembly and polymer electrolyte fuel cell made therefrom, and method of making the electrode material

(75) Inventors: Osamu Sakai, Osaka (JP); Junji Niikura, Osaka (JP); Teruhisa Kanbara, Osaka (JP); Masao Yamamoto, Osaka (JP); Akihiko Yoshida, Osaka (JP); Makoto Uchida, Osaka (JP); Eiichi Yasumoto, Kyoto (JP); Junji Morita, Osaka (JP); Yasushi Sugawara, Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Matsushita Electric Industrial Co., Ltd.

(21) Appl. No.: 10/426,217

(22) Filed: Apr. 30, 2003

Related U.S. Application Data
(63) Continuation-in-part of application No. PCT/JP02/04006, filed on Apr. 22, 2002.

(30) Foreign Application Priority Data
Apr. 27, 2001 (JP) JP2001-132972
Jul. 3, 2001 (JP) JP2001-202286

(51) Int. Cl. H01M 4/94; H01M 4/96; H01M 4/88; H01M 8/10

(52) U.S. Cl. 429/42; 429/44; 429/30; 502/101

(57) ABSTRACT

An electrode material, particularly a gas diffusion layer, for a fuel cell is provided which prevents electrode exfoliation during the manufacturing process by optimizing a water repellent material incorporated in the gas diffusion layer. The resulting electrode made from the gas diffusion layer has a high discharge performance at a low cost. This gas diffusion layer contacts a catalyst layer to form an electrode of the fuel cell layer, and the catalyst layer in turn contacts a polymer electrolyte membrane of the fuel cell. The gas diffusion layer contains a fibrillatable, water repellent material, and is subjected to heat treatment below the melting point of the water repellent material to fibrillate the material.

### CROSS REFERENCE TO RELATED APPLICATION

This is a continuation-in-part of International Application No. PCT/JP02/04006, filed Apr. 22, 2002, the disclosure of which is incorporated herein by reference.

### BACKGROUND OF THE INVENTION

The present invention relates to a fuel cell directly using, as a fuel, pure hydrogen, a reformed hydrogen from methanol or a fossil fuel, or a liquid fuel such as methanol, ethanol or dimethyl ether, and using air or oxygen as an oxidant. More particularly, the invention relates to an electrode material, particularly a gas diffusion layer for a fuel cell using a solid polymer as an electrolyte, as well as a membrane-electrode assembly and polymer electrolyte fuel cell made therefrom, and a method for making such a gas diffusion layer.

In a polymer electrolyte fuel cell a fuel gas, such as hydrogen, is electrochemically reacted with an oxidant gas, such as air, by gas diffusion electrodes each having a catalyst layer provided with a catalyst such as platinum, whereby electricity and heat are simultaneously generated. A general structure of such a polymer electrolyte fuel cell is shown in FIG. 1.

Referring to FIG. 1, catalyst layers 2 each having, as a main ingredient, carbon powder carrying a platinum group metal catalyst are arranged in intimate contact with both surfaces of a polymer electrolyte membrane 1 which selectively transports hydrogen ions. A pair of gas diffusion layers 3 having both gas permeability and electric conductivity is respectively arranged in intimate contact with the outer surfaces of the catalyst layers. The gas diffusion layers 3 and the catalyst layers 2 constitute electrodes 4. Electrically conductive separator plates 6 for mechanically fixing an electrolyte membrane-electrode assembly (MEA) 5 formed by the electrode 4 and the polymer electrolyte membrane 1 and for electrically connecting neighboring MEAs in series are arranged on outside surfaces of the electrodes 4.

The separator plates 6 have, on surfaces thereof contacting the electrodes 4, gas flow channels 7 for supplying reactive (fuel and oxidant) gases to the electrode and for carrying away water generated by the reaction and excess reactive gas(es). The gas flow channels 7 can be provided independently of the separator plates 6, but it is conventional to provide grooves, as the gas flow channels, on the surfaces of the separator plates. In the example shown in FIG. 1 a combination of a separator plate 6a having gas flow channel 7a for supplying a fuel gas to the anode and a separator plate 6b having gas flow channel 7b for supplying an oxidant gas to the cathode forms between them a flow channel 8 for cooling water. Reference numeral 9 designates a gasket arranged at a peripheral portion of the electrode.

In many fuel cells a stack structure is employed in which a large number of unit cells, each having a structure as described above, are stacked. According to such a polymer electrolyte fuel cell stack as described above, the cell as a whole needs to be constantly tightened in order to reduce the electric contact resistances of the constituting components such as separator plates, and to maintain the sealing properties against the fuel gas and the oxidant gas. For this purpose, end plates are respectively arranged on both ends of the structure having the large number of unit cells stacked in one direction, and both end plates are fixed with each other by tightening elements in order to provide a tightening pressure.

The gas diffusion layer in an electrode of such a polymer electrolyte fuel cell mainly has the following three functions. The first one is the function of diffusing reactive gases for uniformly supplying the reactive gases, i.e., the fuel gas and the oxidant gas, to the catalyst in the catalyst layer from the gas flow channels provided at the outer surfaces of the gas diffusion layer. The second one is the function of immediately exhausting, to the gas flow channels, water generated by the reaction at the catalyst layer. The third one is the function of conducting electrons, which are needed for or generated by the reaction. Therefore, suitably high permeability properties for the reactive gases and water vapor, as well as a high electronic conductivity, are needed therein. According to conventional prior art, it has been attempted to respectively realize: the gas permeability performance by allowing the gas diffusion layer to have a porous structure; the water vapor permeability performance by diffusing in the layer thereof, e.g., a water repellent polymer as represented by a fluorocarbon resin; and the electronic conductivity by structuring the gas diffusion layer with an electronically conductive material, such as carbon fiber, metal fiber or fine carbon powder.

Various attempts for improving the above-described gas permeability performance, water vapor permeability performance and electronic conductivity cause effects contradictory to each other. For example, an increase of the porosity in the gas diffusion layer, e.g., by decreasing the diameter and the amount of carbon fibers for the purpose of improving the gas permeability performance, causes the electronic conductivity to be lowered. Further, an addition of water repellent polymer for the purpose of improving the water permeability performance causes the gas permeability performance and the electronic conductivity to be lowered. Thus, various attempts have been made to successfully realize the above contradictory functions, e.g., by combining a layer formed by carbon fibers with a layer formed by fine carbon powder and a water repellent polymer, rather than by a single structure of the gas diffusion layer. However, there have been few examples which specifically determine various properties for the above-described water repellent polymer to have as the gas diffusion layer.

For example, known representative examples of methods of using water repellent polymers include: a method of subjecting a carbon paper or carbon cloth (to be used as a gas diffusion layer for an electrode material) to an immersion process in a dispersion of polytetrafluoroethylene (PTFE) as disclosed, for example, in Japanese Laid-open Patent Publication Hei 6-203851; and a method of forming a layer of fine carbon powder having PTFE added thereto. Further, according to a generally employed method, after a layer of fine carbon powder having PTFE added thereto is formed, it is subjected to a heat treatment at or above the melting point of the water repellent material and at or above the boiling point of a surfactant.

However, the carbon paper and the carbon cloth have, at their surfaces, needle-like convex-concave portions due to the carbon fibers. Accordingly, when the carbon paper or the carbon cloth is directly contacted with the catalyst layer, pinholes are generated at the polymer electrolyte membrane, which cause internal short-circuiting. For this reason, it is necessary to form a water repellent layer between the carbon paper or carbon cloth and the catalyst layer. Here, if the electrode material is subjected to a heat treatment at or above the melting point of the water repellent material for improving the water repelling effect of the water repellent material, the electrode suffers a problem of exfoliation due to a decrease of the bonding strength thereof. This brings about the consequences of a decrease of discharge performance of the electrode and an increase of man-hours due to a decrease of handleability in cell assembling.

The polymer electrolyte membrane of the polymer electrolyte fuel cell has such physical properties that its ionic conductivity increases as the water content therein increases. Accordingly, it is necessary to keep the polymer electrolyte membrane and the polymer electrolyte in the catalyst layer in a wet condition. However, if the condition becomes excessively wet, the porous portions in the gas diffusion layer and the gas flow channels of the separator plates are blocked by condensed water, resulting in a flooding state, in which the cell performance deteriorates extremely due to the impairment of the gas diffusion. In order to provide a high performance polymer electrolyte fuel cell, it is indispensable to keep the polymer electrolyte at an appropriately wet condition and to eliminate excessive water safely and immediately.

Usually, it is difficult to maintain an appropriately wet condition by only water generated during the cell operation, so that one or another method of humidification is generally used for supplying a reactive gas and water content to an MEA to humidify the MEA. When the amount of humidification decreases, a problem arises in that the output voltage significantly degrades. However, as the method of humidification is simplified and as the amount of humidification decreases, the humidification and the cell operation can be more stable and safer, which enables an improvement of the operational efficiency of the fuel cell system.

### BRIEF SUMMARY OF THE INVENTION

The present invention is intended to solve the above-described problems of the prior art by optimizing the water repellent material in the gas diffusion layers.

An object of the present invention is to provide a gas diffusion electrode material which can provide a fuel cell having no problem of electrode exfoliation during the manufacturing process and having a high discharge performance.

For solving the foregoing problems according to the present invention, a gas diffusion layer is provided for forming a fuel cell electrode (also referred to as a “gas diffusion electrode” of a fuel cell) having a catalyst layer at a surface thereof to contact a polymer electrolyte membrane, wherein the gas diffusion layer contains a fibrillated water repellent material. Preferably, the gas diffusion layer has a layer of water repellant, electrically conductive particles on the surface thereof which contacts the catalyst layer.

According to one embodiment of the invention, the gas diffusion layer for the fuel cell has water repellant, electrically conductive particles distributed substantially throughout the entire gas diffusion layer.

The present invention further provides a method of making a gas diffusion layer for a fuel cell, which gas diffusion layer forms an electrode having a catalyst layer at a surface thereof to contact a polymer electrolyte membrane, comprising a step of incorporating in the gas diffusion layer a water repellent material which can be fibrillated, and a step of subjecting the gas diffusion layer to a heat treatment below the melting point of the water repellent material to fibrillate the water repellent material.

It is preferred that the above-described water repellent material be polytetrafluoroethylene having a molecular weight greater than about 1 million, and that the above-described heat treatment temperature be in a range of about 270° C. to 330° C.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a cross-sectional view showing the general structure of a polymer electrolyte fuel cell.

FIG. 2 is a simplified schematic diagram showing a water repellent material according to the present invention.

FIG. 3 is a simplified schematic diagram showing a conventional water repellent material.

FIG. 4 is a graph showing a comparison of current-voltage characteristics of examples of hydrogen-air fuel cells.

FIG. 5 is a graph showing a comparison of current-voltage characteristics of examples of liquid fuel cells.

FIG. 6 is graph showing current-voltage characteristics of a fuel cell according to Example 3 and those of a fuel cell according to Comparative Example 5.

FIG. 7 is a graph showing current-voltage characteristics of fuel cells according to Example 4.

FIG. 8 is graph showing current-voltage characteristics of a fuel cell according to Example 3 and those of a fuel cell according to Comparative Example 6.

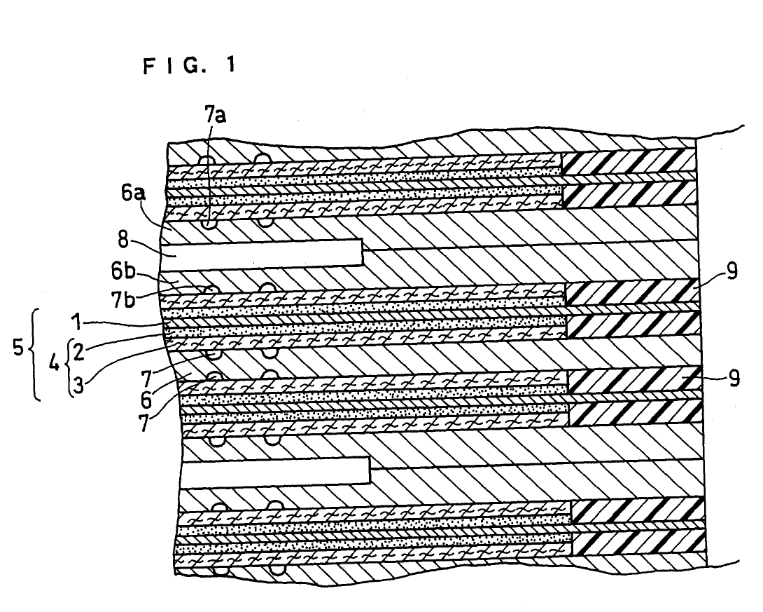

### DETAILED DESCRIPTION OF THE INVENTION

A gas diffusion layer electrode material for a fuel cell according to the present invention is characterized in that the gas diffusion layer contains a fibrillated, water repellent material. Due to the fibrillation of the water repellent polymer of the water repellent material, the bonding strength of the water repellent material to the gas diffusion layer increases, so that the ionic conductivity increases, and the areas which retain water decrease, resulting in an electrode which is resistant to flooding. Thus, the discharge performance and the productivity of the electrode increase.

A water repellent polymer to be used here is preferred to be a polytetrafluoroethylene (PTFE) having a molecular weight greater than about 1 million. The melting point of PTFE is about 327° C. to 347° C. PTFE is a generally widely used water repellent material. It is a water repellent material which can be reduced in its cost and can be easily fibrillated, so that an electrode material showing a high bonding strength can be easily obtained.

The temperature at which the gas diffusion layer having a water repellent material incorporated therein is to be subjected to heat treatment should be lower than the melting point of the water repellent material, preferably a temperature at which the fibrillated portions do not become softened and burned off. A preferable heat treatment temperature is about 270° C. to 330° C. for PTFE. Thus, a fundamental purpose of the heat treatment is to decompose the surfactant in the aqueous dispersion of PTFE by heat and to blow off the decomposed surfactant. While not intending to be bound by any particular mechanism or theory, it is believed that the shape or configuration of PTFE changes as the temperature of the heat rises as follows:

(a) At a temperature of about 150° C. the branches (fibrillation) of PTFE grow and extend in a manner to weave through the pores among the carbon particles in the gas diffusion layer, more specifically in the water repellent layer at the surface of the gas diffusion layer, and through the pores among the fibers in the gas diffusion layer (carbon cloth, carbon paper or the like);

(b) Toward a temperature a little below the melting point (340° C.) of the PTFE, the bonding strength of PTFE to the carbon particles in the water repellent layer and the fibers in the gas diffusion layer increases;

(c) When the temperature further rises to about 400° C., the branches (fibrillation) of PTFE start being cut or broken; and

(d) At a temperature of about 1000° C. PTFE sublimes.

According to the present invention, the heat treatment of PTFE is performed a little below 340° C. in order to (i) blow off the surfactant and (ii) increase the bonding strength of the PTFE to the carbon particles and fibers of the gas diffusion layer. Conventionally, such heat treatment was performed at about 400° C. for PTFE. Of course, it will be understood that the heat treatment temperature of the present invention will be varied depending on the melting point of the particular polymer used for the water repellent material.

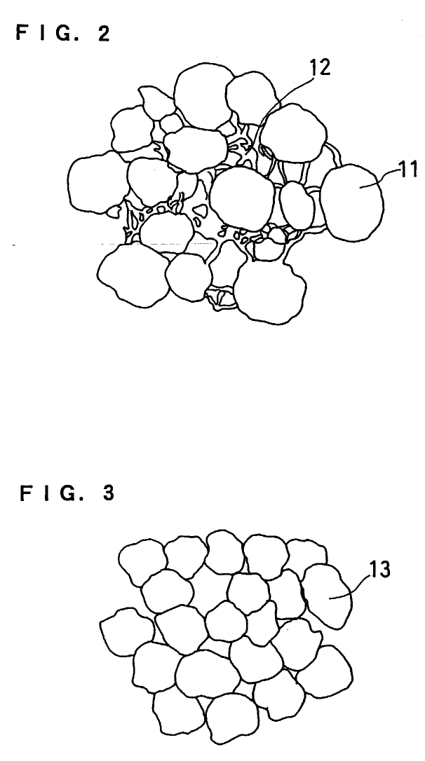

FIG. 2 schematically shows primary particles 11 of a water repellent material to be used for the present invention. The polymer used for the water repellent material according to the present invention can be easily fibrillated, and generates portions 12 where it is fibrillated in a web form, which portions cover primary particles 11. The fibrillation is further promoted to increase the fibrillated portions 12, when a shear force is further imposed on the particles, in making the electrode material, e.g., by stirring during the process of making an electrode coating or impregnating material (referred to as the “electrode ink”) and by mechanical resistance at an ink transportation path during the process of ink coating or impregnation. Due to the presence of the fibrillated portions 12, the electrode has increased internal bonding strength, i.e., bonding strength between the gas diffusion layer and the water repellent layer (which is a part of the gas diffusion layer) and bonding strength between the water repellent layer (at the surface of the gas diffusion layer) and the catalyst layer. Possible exfoliations of the electrode at either of these layer junctions are substantially avoided by the increased internal bonding strength of the electrodes produced with the materials of the invention. In addition, there is the bonding strength of the water repellent material to the carbon particles therein. Consequently, the discharge performance of the electrode is improved, and man-hours for the manufacturing process can be reduced.

As shown in FIG. 3, on the other hand, particles 13 of conventional water repellent materials have short molecular chains and do not have sufficient molecular weights, so that fibrillation is hardly generated, even with an imposition of a shear force thereon, and the fibrillated portions do not increase. Further, when these water repellent materials are subjected to heat treatment at or above the melting points thereof, portions 12 having been fibrillated in a web form become softened and re-agglomerate, so that the web-form fibrillated portions 12 undesirably decrease.

By using the gas diffusion layer (electrode material) according to the present invention, a high performance and inexpensive electrode for a fuel cell can be made.

Another object of the present invention, from a different aspect, is to provide a polymer electrolyte fuel cell which does not deteriorate in its performance even with a small amount of humidification.

In order to achieve this object, one embodiment of the present invention provides an electrode material for a fuel cell, in which water repellent, electrically conductive particles are distributed substantially throughout the entire gas diffusion layer.

Here, a porous electrode base material to constitute the gas diffusion layer is preferably made of a carbon material, such as carbon paper, carbon felt or carbon cloth.

The electrically conductive particles are preferred to be carbon particles containing fluorocarbon resin. The fluorocarbon resin is furthermore preferred to be PTFE.

The electrically conductive particles are not localized in the vicinity of one surface of the porous electrode base material, such as by coating the same on the surface of the porous electrode base material, such as carbon paper, which surface is to be in contact with the catalyst layer. Instead, the electrically conductive particles are distributed throughout the porous electrode base material, e.g., by impregnation or pressure-filling. In addition to the porous electrode base material having such water repellent, electrically conductive particles arranged substantially throughout the entire layer, it is also effective to further coat water repellent, electrically conductive particles on a main surface of the porous electrode base material, which surface is to be in contact with the catalyst layer.

When a gas diffusion electrode is made by a conventional method alone, in which water repellent, electrically conductive particles are coated by blade coating or spray coating on a porous electrode base material in the vicinity of a surface thereof, such gas diffusion electrode per se does not have sufficient capacity to maintain a wet condition in the MEA of a polymer electrolyte fuel cell. When such a cell is operated while it is humidified from outside, the cell voltage significantly decreases if the amount of the humidification is decreased.

To counter such problems, a more suitable wet condition of the polymer electrolyte can be realized according to one embodiment of the present invention by distributing water repellent, electrically conductive particles substantially throughout the entire porous electrode base material, namely the gas diffusion layer. Thereby, a gas diffusion layer can be provided having a sufficient thickness, a superior performance of maintaining the wet condition in the polymer electrolyte, electric conductivity and water repellency.

In order to enable a smaller amount of humidification from the outside, one general prior art method is to preliminarily subject a porous electrode base material to a water repellency treatment by using, for example, a dispersion of fluorocarbon resin. However, according to comparative studies, it has been found that the gas diffusion electrode material according to the present invention has a higher capability of maintaining a wet condition. Furthermore, the gas diffusion electrode material according to the present invention can be made by a simpler manufacturing process.

It can be confirmed that the gas diffusion electrode material according to the present invention shows the effect of requiring a smaller amount of humidification in either case whether the electrode material is placed at the anode or the cathode alone. However, it shows the greatest effect of a smaller amount of humidification when the gas diffusion electrode materials according to the present invention are placed at both electrodes.

As described above, in a polymer electrolyte fuel cell, in which it is important to keep the electrolyte at a suitable wet condition, the present invention provides a gas diffusion electrode which exhibits a high output voltage even under a condition of a small amount of humidification from outside.

The present invention will now be described with reference to the following specific, non-limiting examples.

### EXAMPLE 1

30 parts (dry weight basis) of PTFE in an aqueous dispersion (product of Daikin Industries, Ltd.: D-1) containing 60 wt % PTFE, 3 wt % surfactant (octylphenoxypolyethoxy ethanol) and 37 wt % water was mixed with 100 parts acetylene black powder (product of Denki Kagaku Kogyou Kabushiki Kaisha: Denka Black) in additional water and surfactant to formulate an electrode ink. The mixing here was carried out by using a colloid mill for 30 minutes to form the dispersion and thereby impose shear force thereon. This electrode ink was coated on one surface of a carbon paper (product of Toray Industries, Inc.: TGPHO60H), which was then subjected to heat treatment by a hot air drier at 280° C. for 20 minutes, thereby producing a gas diffusion layer having a water repellent layer.

Meanwhile, catalyst layers were formed on both surfaces of a polymer electrolyte membrane (product of DuPont Company: Nafion 112 membrane). The catalyst layer was made by forming a mixture of 96 parts by weight of an electrically conductive fine carbon powder (product of Lion Corporation: Ketjenblack EC) carrying a platinum catalyst in a 1:1 weight ratio and 4 parts by weight of a polymer electrolyte, the same as the above-described polymer electrolyte membrane. A gas diffusion layer, as produced above, was then overlaid on and in contact with the catalyst layer on each surface of the polymer electrolyte membrane, and these were bonded by thermal fusion at 160° C., thereby producing an electrolyte membrane-electrode assembly (MEA). Using this MEA, unit cell I of a hydrogen-air type fuel cell was assembled.

### COMPARATIVE EXAMPLE 1

A gas diffusion layer was made in a manner similar to that in Example 1, except that here an aqueous dispersion of a copolymer of tetrafluoroethylene-hexafluoropropylene (product of Daikin Industries, Ltd.: ND-1) was used for making a water repellent layer ink, in place of the aqueous dispersion of PTFE. Using this gas diffusion layer, an MEA was made in a manner similar to that in Example 1. It was found that in this MEA an exfoliation occurred between the gas diffusion layer and the catalyst layer. Using this MEA, unit cell II similar to the one in Example 1 was assembled.

### COMPARATIVE EXAMPLE 2

A gas diffusion layer was made in a manner similar to that in Example 1, except that here the temperature of the heat treatment, after coating of the electrode ink on one surface of the carbon paper, was changed to 350° C. Using this gas diffusion layer, an MEA was made in a manner similar to that in Example 1. It was found that in this MEA, an exfoliation occurred between the gas diffusion layer and the catalyst layer. Using this MEA, unit cell III similar to the one in Example 1 was assembled.

### EXAMPLE 2

Using the MEA of Example 1, a liquid fuel unit cell X was assembled.

### COMPARATIVE EXAMPLE 3

Using the MEA of Comparative Example 1, a liquid fuel unit cell Y was assembled.

### COMPARATIVE EXAMPLE 4

Using the MEA of Comparative Example 2, a liquid fuel unit cell Z was assembled.

The fuel cells according to the above Example 1 (present invention) and Comparative Examples 1 and 2 were subjected to cell discharge tests by: supplying to the respective anodes thereof a pure hydrogen gas humidified to have a dew point of 70° C.; supplying to the respective cathodes thereof air humidified to have a dew point of 50° C.; and setting the cell temperature at 75° C., the fuel gas utilization rate at 70% and the air utilization rate at 40%.

Further, the fuel cells according to the above Example 2 (present invention) and Comparative Examples 3 and 4, i.e., unit cells as direct type methanol fuel cells, were subjected to cell discharge tests by: supplying to the respective anodes thereof an aqueous solution of 2 mol/L methanol at a temperature of 60° C. as a representative example of a liquid fuel; supplying to the respective cathodes thereof air humidified to have a dew point of 60° C.; and setting the cell conditions of temperature at 75° C. and air utilization rate at 40%.

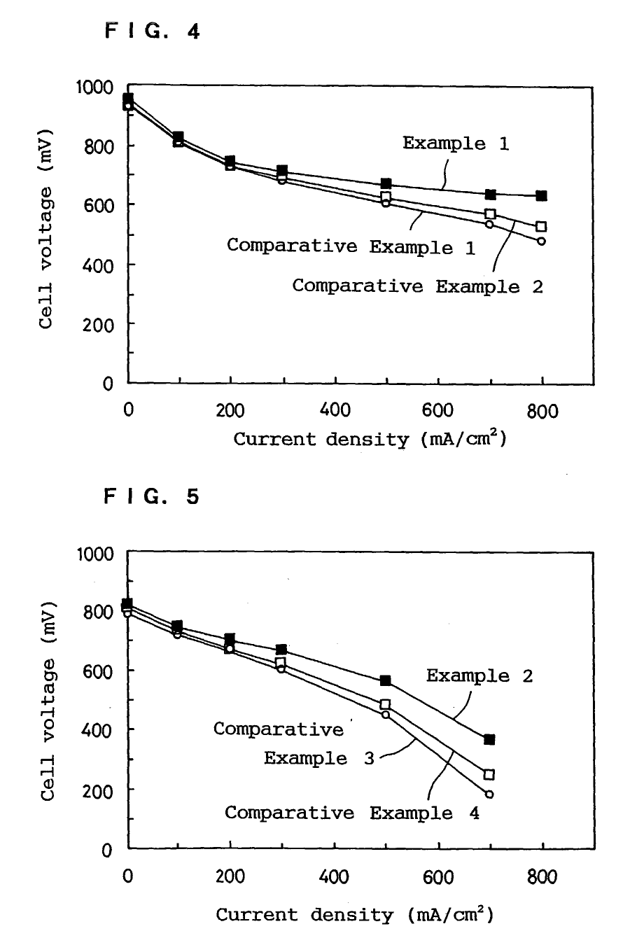

FIG. 4 shows average values of discharge characteristics of the unit cells I, II and III according to Example 1 and Comparative Examples 1 and 2 as hydrogen-air fuel cells. Noting the cell voltages at a current density of 800 mA/cm², the voltages of unit cells I, II and III were 635 mV, 481 mV and 529 mV, respectively in this order. As evident from FIG. 4, the higher the current densities become, the more the discharge voltages differ. As the current density increases, water generated from a cell proportionally increases, so that delicate intimacy of the electrode has influences thereon. Portions of the electrode material, which have degraded bonding strengths, have lowered water repellent effects. Accordingly, water stays locally at such portions, resulting in a degraded gas diffusion capability. The thus influenced portions of the electrode material cause degraded power generation, resulting in lower discharge performance thereof. On the other hand, tight bonding of the electrode material can be realized by the fibrillation of the water repellent material, so that high water repellent effects can be maintained for a long period. Thus, the fuel cell according to this embodiment of the present invention has brought about a consequence of high durability.

FIG. 5 shows average values of discharge characteristics of the unit cells X according to Example 2 of the present invention and unit cells Y and Z according to Comparative Examples 3 and 4 as liquid fuel cells. Noting the unit cell voltages at a current density of 300 mA/cm², the voltages of unit cells X, Y and Z were 666 mV, 601 mV and 620 mV, respectively.

Further, presence or absence of exfoliations of electrodes made in the Examples according to the present invention and those in the Comparative Examples was confirmed. As a result, out of 50 cells made according to Example 1, none of the 50 cells had electrode exfoliations generated therein. In contrast, out of 50 cells according to each of Comparative Examples 1 and 2, 40 cells of Comparative Example 1 and 50 cells of Comparative Example 2 had electrode exfoliations generated therein. One factor to have caused such electrode exfoliations is a degraded bonding strength, because fibrillated portions of the water repellent material were subjected to heat treatment at a temperature at or above the melting point thereof, so that the fibrillated portions of the water repellent particles became softened and re-agglomerated, and the fibrillated portions decreased. Another factor to have caused the electrode exfoliations is the inherent low molecular weight of the water repellent material, which prevented fibrillation thereof and caused degraded bonding strength, so that the electrode material could not withstand the shape change by expansion and shrinkage due to water content change in the membrane.

With respect to the voltage variations of unit cells I, II and II according to Example 1 and Comparative Examples 2 and 3 at a current density of 200 mA/cm², that of unit cell I in terms of standard deviation was 2.08, whereas those of unit cells II and III were 4.22 and 5.17, respectively, indicating variations twice as much or more. A factor of this variation was attributed to variations of bonding at the membrane-electrode assemblies. Due to variations of the bonding strengths of the water repellent layers of unit cells, local spaces were generated where water repellency degraded. Thus, water could remain, whereby consequently the fuel cells showed the variations of discharge performance. In the case of fuel cells, plural unit cells are usually connected in series or parallel in actual use. Therefore, the variations in performance of unit cells greatly influence performance of fuel cell stacks. In the case of a series connection, in particular, the limit current value of a unit cell having the lowest characteristics in a fuel cell stack becomes the limit current value of the whole fuel cell stack, so that the unit cell having the lowest performance defines the limit value of performance of the whole fuel cell stack. In other words, it becomes a further important problem to reduce variations of performance among unit cells. The electrode material for a fuel cell according to the present invention enables dense bonding by the fibrillation of water repellent materials, and thereby reduces variations of discharge performance of unit cells, and consequently improves the discharge performance of fuel cell stacks.

Furthermore, because of the fibrillation of the water repellent materials, electrode exfoliations are no longer generated, so that it becomes possible to shorten the time for making stacks in a stack assembly process, thereby enabling reduction of manufacturing cost. Moreover, although hydrogen and methanol were used in the above Example as examples of a fuel, similar results can be obtained even by a fuel in which pure hydrogen is substituted with a reformed hydrogen containing impurities such as carbon dioxide, nitrogen and carbon monoxide. Also, it is needless to mention that similar results can be obtained even by a liquid fuel such as ethanol, dimethyl ether or a mixture thereof in place of methanol. Further, the liquid fuels can be supplied by being preliminarily evaporated.

The structure of the gas diffusion layer is not limited to such fine carbon powder or carbon paper as shown in the Example, but effective results can also be obtained by using other carbon black or carbon cloth.

### EXAMPLE 3

First of all, a method of making a catalyst layer will be described. A carbon powder having a particle size of a few micrometers was immersed in an aqueous solution of chloroplatinic acid and was subjected to a reduction treatment, thereby allowing the carbon powder to carry platinum catalyst on its surface. The weight ratio of the carbon and the carried platinum was 1:1. Next, the carbon powder carrying the platinum was dispersed in an alcohol solution of a polymer electrolyte, thereby obtaining a slurry.

The slurry containing the carbon powder carrying the catalyst was coated on a film base material, and was dried to form a catalyst layer. The catalyst layer was transferred onto a polymer electrolyte membrane, thereby producing a polymer electrolyte membrane with catalyst layers. The catalyst layers were designed to have a smaller outside dimension than a carbon paper to be joined thereto later, such that the outer periphery of the carbon paper extends beyond the catalyst layer by a few millimeters.

Next, a water repellent carbon layer will be described. A granulated powder of acetylene black was dispersed in water containing a surfactant additive. Then, an aqueous dispersion of PTFE was added thereto, and the mixture was well mixed by a colloid mill, thereby formulating a slurry of water repellent carbon.

Into this water repellent carbon slurry, a carbon paper having a thickness of 360 μm was immersed, and the container for the slurry was maintained at a reduced pressure in order to impregnate the water repellent carbon slurry, as an electrode ink, into substantially the entire carbon paper. The impregnated paper was then pulled out and dried, and was thereafter subjected to heat treatment at 280° C. for 20 minutes.

The carbon paper thus having the water repellent carbon impregnated therein was cut to a given size. Such carbon papers were overlaid on both surfaces of the above-described polymer electrolyte membrane with catalyst layers so as to cover the entire catalyst layers. Then gaskets were aligned with peripheral portions of the carbon paper and pressed at 100° C. for 5 minutes, thereby producing an MEA.

Polymer electrolyte fuel cell A having thus been made as above was subjected to an aging operation for 12 hours, and was evaluated as to its current-voltage characteristics under two conditions with different dew points at the cathode side. Hydrogen humidified to have a dew point of 70° C. was supplied to the anode at a flow rate to yield a utilization rate of 70%, while humidified air was supplied to the cathode at a flow rate to yield a utilization rate of 40%.

First, the current-voltage characteristics were measured under the condition that the dew point (Tdc) of the air supplied to the cathode was 60° C. Thereafter, the dew point of the air to be supplied to the cathode was changed to 45° C., and was subjected to an aging operation for 8 hours. Then, the current-voltage characteristics were measured again to obtain current-voltage characteristics at an air dew point of 45° C. The cell temperature was maintained at 75° C.

### COMPARATIVE EXAMPLE 5

A fuel cell B, i.e., a conventional cell, was made in a manner similar to that in Example 3 by using a gas diffusion electrode material, wherein a water repellent carbon layer, deposited as an electrode ink, was coated by blade coating localized at a surface of a porous electrode base material, which surface is to contact a catalyst layer.

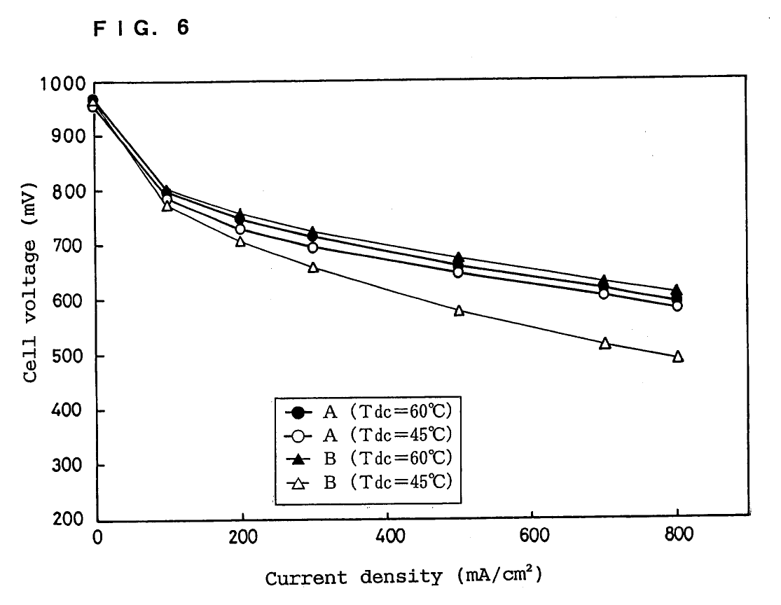

The current-voltage characteristics of fuel cell A according to Example 3 and fuel cell B according to Comparative Example 5 are shown in FIG. 6. From the results thereof, it can be recognized that the polymer electrolyte fuel cell using the gas diffusion electrode material according to the present invention shows a high output voltage even under a condition of low humidification.

### EXAMPLE 4

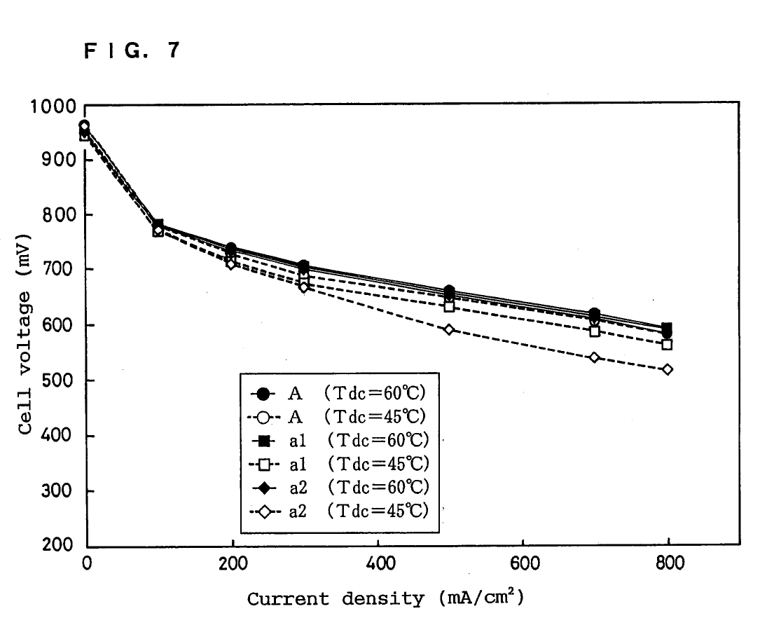

FIG. 7 shows the characteristics of cells a1 and a2 having a gas diffusion electrode material of Example 3 only for the anode (a1) and only for the cathode (a2), respectively, in comparison with cell A having such gas diffusion electrode materials for both electrodes. From the results thereof, it can be recognized that in both cases of placing the gas diffusion electrode material according to the present invention only at the anode and only at the cathode, the output voltage under a condition of low humidification can be improved. Further, the greatest effect at low humidification can be obtained in the case where the gas diffusion electrode materials according to the present invention are placed at both the anode and the cathode.

### COMPARATIVE EXAMPLE 6

A gas diffusion electrode material according to the present invention was compared with a gas diffusion electrode material which had an electrically conductive and water repellent layer coated thereon after the electrode base material was preliminarily subjected to water repellency treatment.

A method of making a fuel cell, as a comparative example, will be described.

A carbon paper, for use as an electrode base material, having a thickness of 360 μm was immersed in an aqueous dispersion of fluorocarbon resin, and was then dried. On one main surface of the porous electrode base material thus provided with water repellency, a slurry of water repellent carbon as used in Example 3 was coated, and was subjected to heat treatment at 280° C. for 20 minutes. Next, two sheets of the above-described carbon paper, each having been subjected to the water repellency treatment and coated with the water repellent carbon layer and having been cut to have a given size, were overlaid on both surfaces of a polymer electrolyte membrane with catalyst reactive layers, so as to cover the entire catalyst layers thereby. Then, gaskets were aligned with peripheral portions thereof and pressed at 100° C. for 5 minutes, thereby producing an MEA in a manner similar to that in Example 3.

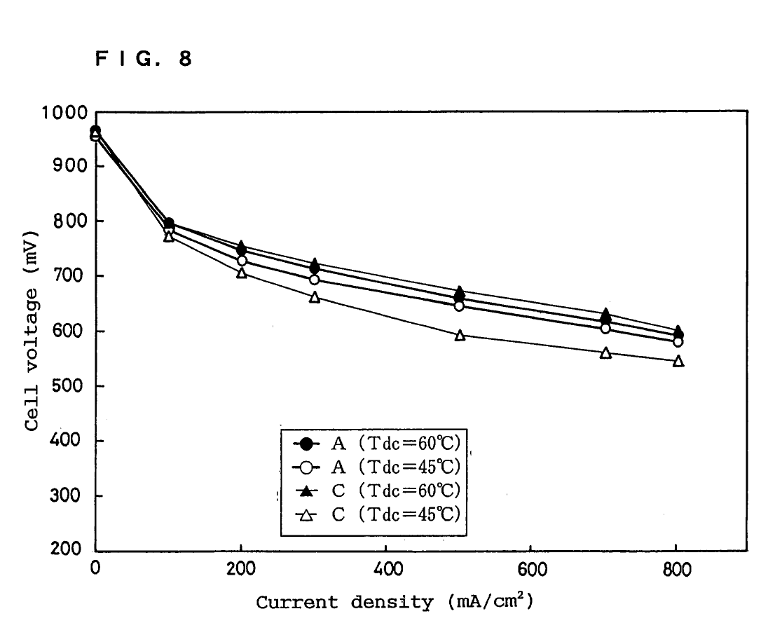

FIG. 8 shows the characteristics of cell C using this MEA under the conditions similar to those in Example 3. From the results thereof, it can be recognized that comparing polymer electrolyte fuel cell A (using a gas diffusion electrode material according to the present invention) with polymer electrolyte fuel cell C (using a gas diffusion electrode material having an electrically conductive and water repellent layer coated thereon after the electrode base material thereof is preliminarily subjected to water repellency treatment), the former has a higher output voltage under a condition of low humidification. In other words, in a cell using the gas diffusion electrode material according to the present invention, degradation of its performance by a decrease in the amount of humidification can be better suppressed.

### INDUSTRIAL APPLICABILITY

As described above, according to the present invention, it is possible to uniformly supply reactive gases to the catalyst of the catalyst layers and to immediately exhaust generated water and generated carbon dioxide. It is also possible to reduce man-hours in the manufacturing process and to provide a polymer electrolyte fuel cell and an electrode material for a liquid fuel cell that are inexpensive and have high discharge performance and high durability.

Further, by distributing electrically conductive and water repellent particles throughout the gas diffusion layer, gas diffusion electrodes can be obtained having the superior performance of maintaining polymer electrolytes at wet conditions. Using such gas diffusion electrode materials, it becomes possible to provide a polymer electrolyte fuel cell in which output degradation is suppressed under a condition of low humidification.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A gas diffusion layer for a fuel cell in which a polymer electrolyte membrane-electrode assembly has a hydrogen ion conductive polymer electrolyte membrane and a pair of electrodes, each comprising a gas diffusion layer and a catalyst layer, sandwiching the polymer electrolyte membrane, such that the gas diffusion layer contacting the catalyst layer which in turn contacts the polymer electrolyte membrane, the gas diffusion layer comprising a fibrillated, water repellent material and a layer of water repellent, electrically conductive particles on a surface of the gas diffusion layer for contacting the catalyst layer.

2. The gas diffusion layer according to claim 1, wherein the water repellent material comprises polytetrafluoroethylene having a molecular weight greater than about 1 million.

3. The gas diffusion layer according to claim 1, wherein water repellent, electrically conductive particles are further distributed substantially throughout the gas diffusion layer.

4. The gas diffusion layer according to claim 3, wherein the water repellent, electrically conductive particles distributed substantially throughout the gas diffusion layer comprise carbon particles containing fluorocarbon resin.

5. The gas diffusion layer according to claim 1, wherein the gas diffusion layer comprises a porous base material in which the fibrillated, water repellent material is incorporated and whose surface has the layer of water repellent, electrically conductive particles thereon.

6. A polymer electrolyte membrane-electrode assembly comprising at least one gas diffusion layer according to claim 1 with a catalyst layer sandwiched between the at least one gas diffusion layer and a polymer electrolyte membrane.

7. The polymer electrolyte membrane-electrode assembly according to claim 6, comprising two gas diffusion layers according to claim 1, the two gas diffusion layers located on opposite sides of the membrane and each gas diffusion layer sandwiching a catalyst layer between itself and one of the sides of the membrane.

8. A polymer electrolyte fuel cell comprising at least one gas diffusion layer according to claim 1.

9. A method of making a gas diffusion layer for a fuel cell, in which the gas diffusion layer faces a polymer electrolyte membrane with a catalyst layer sandwiched therebetween such that the gas diffusion layer and catalyst layer form an electrode of the fuel cell, the method comprising the steps of: incorporating in the gas diffusion layer a fibrillatable, water repellent material, and subjecting the gas diffusion layer to a heat treatment below the melting point of the water repellent material to fibrillate the water repellent material.

10. The method according to claim 9, wherein the water repellent material comprises polytetrafluoroethylene having a molecular weight greater than about 1 million, and the temperature of the heat treatment is in a range of about 270° C. to 330° C.
